(19) United States
(12) Patent Application Publication
(10) Pub. No.: US 2012/0076340 A1
(43) Pub. Date: Mar. 29, 2012

(54) HEADPHONE

(75) Inventors: Takayuki UCHIDA, Sagamihara-shi (JP); Masaaki TANAKA, Yokohama-shi (JP)

(73) Assignee: VICTOR COMPANY OF JAPAN LIMITED, Yokohama-shi (JP)

(21) Appl. No.: 13/246,077

(22) Filed: Sep. 27, 2011

(30) Foreign Application Priority Data
Sep. 28, 2010 (JP) 2010-217295

(51) Int. Cl. H04R 1/10

(52) U.S. Cl. 381/370

(57) ABSTRACT

A headphone 1 is comprised of a driver unit 4, a cord 3a, a housing 5, and a bushing 13. The driver unit 4 generates sound waves depends on supplied sound signals. The cord 3 is connected to the driver unit 4 to supply audio signals to the driver unit 4. The housing 5 stores the driver unit 4 and has a cord inserted hole 10 to insert the cord 3. The bushing 13 is a tube covering the exterior 3a of the cord 3 with a gap g to protect the code 3 from a wire breakage caused by bending. The bushing 13 is set to the cord inserted hole 10. A valve portion 17 is formed on the inner face 13a of the bushing 13 to contact circularized with the exterior of the cord 3.

### CROSS REFERENCE TO RELATED APPLICATIONS

This application claims priority based on 35 USC 119 from prior Japanese Patent Application No. P2010-217295 filed on Sep. 28, 2010, entitled “HEADPHONE”, the entire contents of which are incorporated herein by reference.

### BACKGROUND OF THE INVENTION

1. Field of the Invention

The present invention relates to a headphone.

2. Description of the Related Art

In this technology, a patent document (Japanese patent document 2001-333484) discloses a earphone that is equipped a main body, a speaker unit put in the main body, a code whose one side is connected to the main body and extends from the main body to exterior, and a bushing that supports the code at around an exit of the main body.

Generally, the bushing is set to prevent the code from snapping when the code is bent. In addition, there is a uniform gap between the bushing and the code for an improvement of a flexibility performance of the code that evaluated by the number of times which the code snaps by bent.

Recently, an earphone is used in sport activity, represented by jogging. In this scene, a foreign matter, for example sweat, a drop of water and dust, enters between the bushing and the code and so the performance of the earphone can have a bad influence.

### SUMMARY OF THE INVENTION

An object of this invention is provided a headphone which has a strong durability even if a foreign matter comes in between the bushing and the code. In this specification, “headphone” is regerd as a same meaning of “earphone”.

According to this invention, a headphone has an electro-acoustic tranducer that generates sound waves based on supplied audio signals, a code connected to the electro-acoustic tranducer for providing the audio signals from the outside to the electro-acoustic tranducer, a housing having a code-setting hole to be capable to insert the code and storages the electro-acoustic tranducer, and a bushing that is a cylinder-shaped covering the exterior of the code with a gap for protecting the code from a wire breakage by the code bent and comprises to the code-setting hole. The interior of the bushing has a blocking portion for clinging to the exterior of the code. The blocking portion can be a ring-shaped.

The bushing desirably includes an unbended portion that is not capable to bend because the unbended portion is set in the housing and a bendable portion that is capable to bend because a bendable portion is not covered by the housing. The blocking portion is disposed in the unbended portion of the bushing. It is preferable that the blocking portion is disposed in a colser side to the electro-acoustic tranducer's side in the bushing.

According to this invention, a foreign matter, for example sweat, drop of water and dust, is prevented from entering the gap between the bushing and the code and from achieving to the electro-acoustic tranducer by the bloking portion. Thereof, the headphone can have a performance that, if a foreign matter, for example sweat, drop of water and dust, enters the gap g between the bushing and the code, it could not been affected for the performance.

### BRIEF DESCRIPTION OF DRAWINGS

FIG. 1 is a side view showing the headphone of the first embodiment.

FIG. 2 shows an exploded side perspective view of the headphone of the first embodiment.

FIG. 3 shows a side cross-sectional view of the headphone of the first embodiment.

FIG. 4 shows an enlarged portion view of FIG. 3.

FIG. 5 shows an enlarged portion view of FIG. 4.

FIG. 6 shows an enlarged portion view of FIG. 4.

FIG. 7 shows an enlarged portion view of the second embodiment.

### DETAILED DESCRIPTION OF EMBODIMENTS

### Embodiment 1

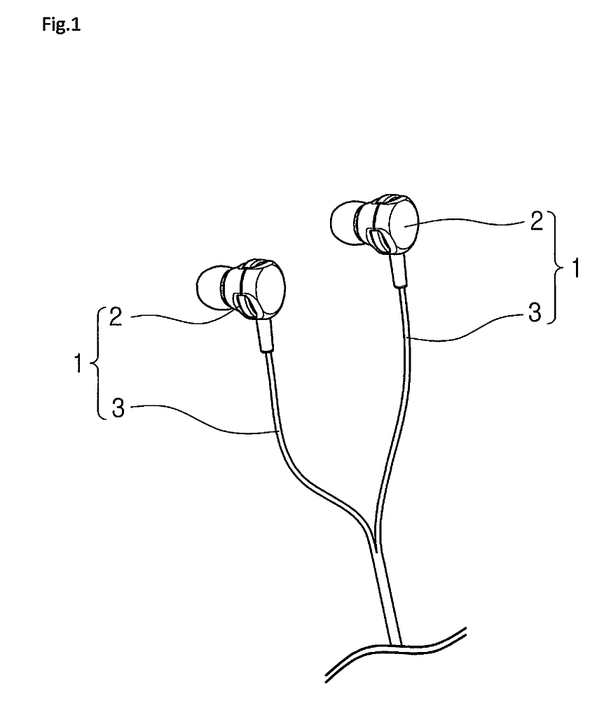

Hereinbelow, embodiments will be described in detail with reference to FIGS. 1 to 6.

The headphone 1 of this embodiment is used in a pair shown in FIG. 1. Each headphone 1 consists of a headphone body 2 and cords 3. Each cords 3 of is connected a plug not illustrated.

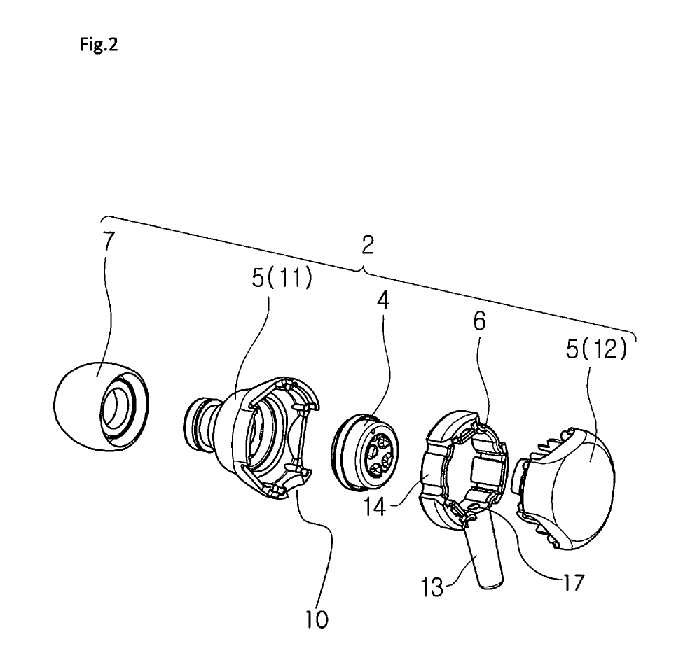

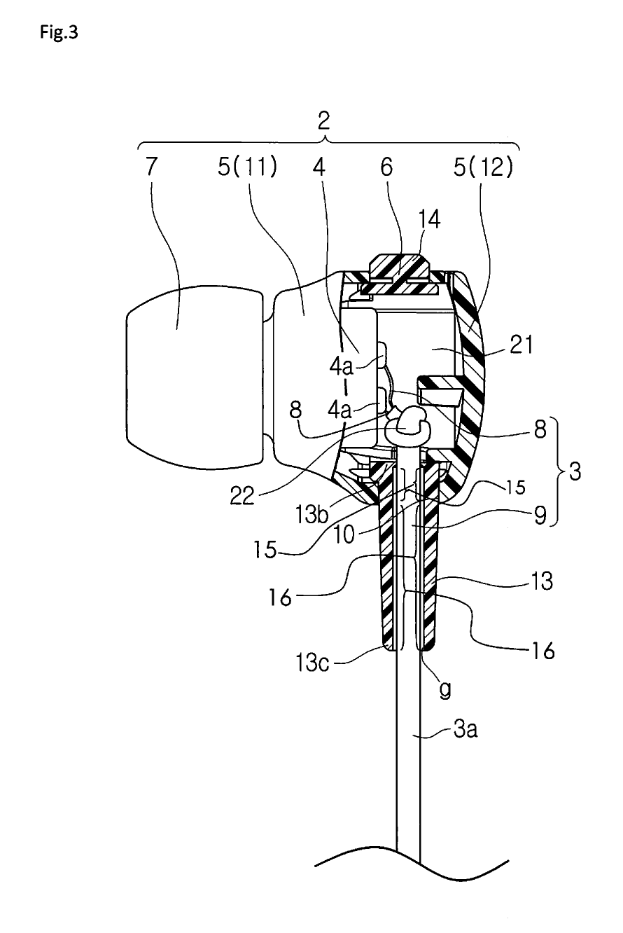

In illustrated in FIGS. 2 and 3, the headphone body 2 is comprised of a driver unit 4, a housing 5, and an ear piece 7 as main components. The cord 3 in FIGS. 1 and 3 is comprised of a core cord 8 that works as a signal line and a cover 9 that covers the core cord 8.

The driver unit 4 is an electro-acoustic tranducer that generates sound waves depends on supplied sound signals. The driver unit 4 is connected to the cord 3. To explain in detail, a terminal 4a of the driver unit 4 is soldered to the core cord 8 and audio signals are supplied from a peripheral device for example audio device, to the driver unit 4 via the cord 3.

The housing 5 stores the driver unit 4 and has a cord inserted hole 10 to insert the cord 3. The housing 5 is comprised of a front housing 11 that is a closer side to the tympanic membrane in using and a rear housing 12 that is a farer side. The cord inserted hole 10 is comprised in a bounder of the front housing 11 and the rear housing 12. A bushing 13 described later is inserted to the cord inserted hole 10.

The bushing unit 6 shown in FIG. 2 includes the bushing 13 and a ring 14.

The bushing 13 shown in FIG. 3 is a tube to cover the exterior 3a of the cord 3 with a gap g and to protect the code 3 from a wire breakage by bending. The exterior 3a of the code 3 corresponds to the outer of the cover 9 of the code 3.

The bushing 13 is set in the cord inserted hole 10 of the housing 5. In detail, a part of the bushing 13 is inserted in the cord inserter hole 10.

The bushing 13 is formed by for instance, elastomer. Hereby, the bushing 13 has an elastic behavior.

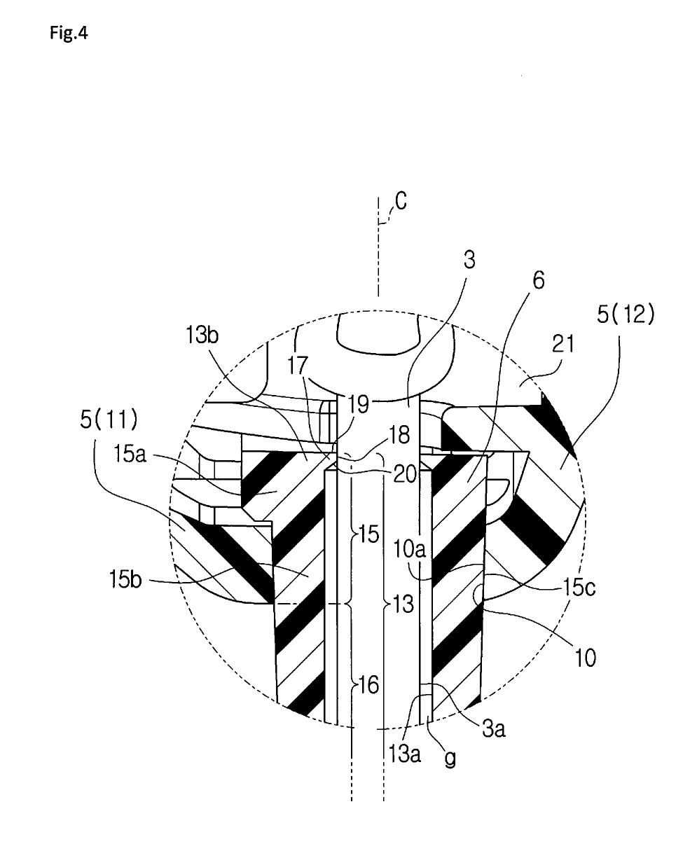

The bushing 13 is comprising of an unbended portion 15 and a bendable portion 16 in shown in FIG. 4. The unbended portion 15 and the bendable portion 16 need not be distinguished from the bushing 13 and are identified portions only when the bushing 13 is set to the housing 5. The unbended portion 15 and the bendable portion 16 will be described later.

The unbended portion 15 is a portion that prevents from a flexion deformity as the unbended portion is set in the housing 5. “The unbended portion 15 stored in the housing 5” is comprised of a covered portion 15a and an uncovered portion 15b. The covered portion 15a is formed thicker than the uncovered portion 15b in the direction of the diameter of the bushing 13 and works as a stopper that prevents the bushing 13 from pulling out of the housing 5. Moreover, the covered portion 15a prevents the bushing 13 from rotating. The uncovered portion 15b is in the cord inserted hole 10. An intentional gap is not formed between the outer face 15c of the uncovered portion 15b and the inner face 10a of the cord inserted hole 10. However, it is possible to be formed partially a gap between an outer face 15c of the uncovered portion 15b and the inner face 10a of the cord inserter hole 10, as in embodiment 2.

The bendable portion 16 is a portion that allows to bend as the bendable portion 16 is not covered from the housing 5.

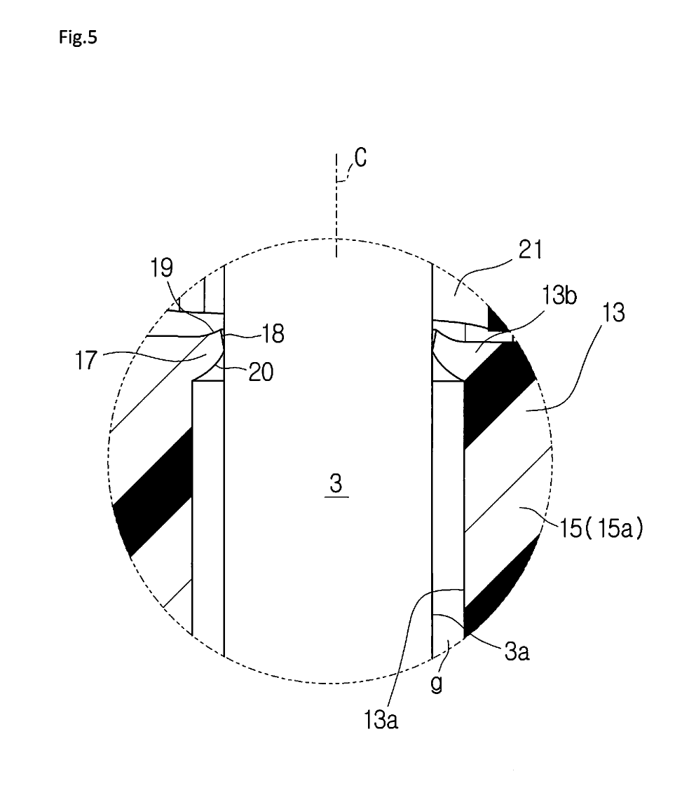

In this embodiments, a valve portion 17 (a blocking portion) is formed on the inner face 13a of the bushing 13 in FIGS. 4 and 5. The valve portion 17 contacts circularized with the exterior of the cord 3. The valve portion 17 is formed at the unbended portion 15 of the bushing 13. Particularly, the valve portion 17 is formed at a covered portion 15a of the unbended portion 15 that is an end 13b (a first end) that is an end at driver unit 4's side of the bushing 13.

The valve portion 17 is connected to the interior of the bushing 13 and projected annularly in the direction form the interior of the bushing 13 to the center axis C. The internal diameter of the valve portion 17 is set as same as the external diameter of the exterior 3a of the cord 3 or a little smaller than the external diameter of the exterior 3a.

The valve portion 17 has a cord side 18, a cavity side 19 and a guide side 20. The cord side 18 is a plat that is parallel to the exterior 3a of the cord 3. The cavity side 19 is a plat facing cavity 21's side in a gap between the driver unit 4 and the housing 5. The guide side 20 is formed with an inclination that is getting more inclined as aparting from the end 13c (a second end, referred in FIG. 2) that is an opposite side of the end 13b (a first end). In other words, the guide side 20 is getting more inclined as getting closer to a knot 22 shown in FIG. 3.

A ring 14 is formed as an annulation shown in FIG. 2. The ring 14 is formed integrately of the bushing. The ring 14 is kept in the housing with sandwiched by the front housing 11 and the rear housing 12.

The ear piece 7 is set to the front housing 11 of the housing 5 shown in FIG. 5.

(Assembly Method)

In fixing method to assemble each parts explained therebelow, a known gluing and welding can be adoptted.

To assemble the headphone 1 explained above, the driver unit 4 is set to the front housing 11 of the housing 5 in a state shown in FIG. 2.

Moreover, the code 3 is inserted the bushing unit 6 from an exposed end of portion 13c's side to an end portion 13b's side. The knot 22 is made of one end of the cord 3 and the core cord 8 is slightly exposed with peeled the cover 9 of the cord 3.

Next, the bushing unit 6 is set to the rear housing 12 of the housing 5. In this state, each end of the core cord 8 of the cord 3 is soldered to each terminal 4a of the driver unit 4.

Then, the bushing unit 6 is mounted to the front housing 11 with sandwiched by the front housing 11 and the rear housing 12. Finally, ear piece 7 is set to the front housing 11 of the housing 5 and then the headphone 1 becomes a product. This setting method makes the ear piece 7 detached as the ear piece 7 is simply fit to the front housing 11.

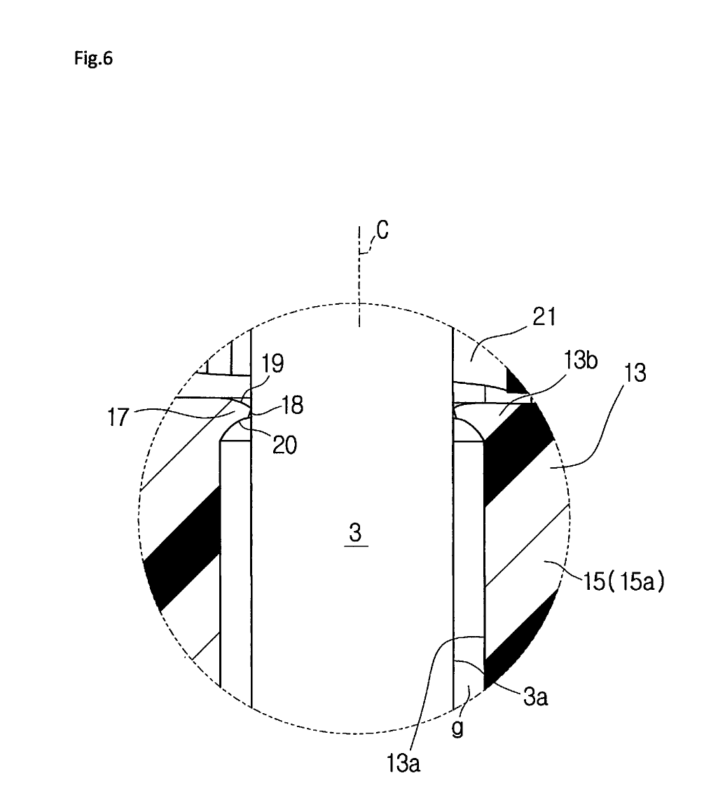

Further, FIG. 5 shows the state that the valve portion 17 of the bushing 13 is contacted strongly to the exterior 3a of the cord 3. In FIG. 5, the valve portion 17 is lightly deformed with an elastication to the cavity side 19. FIG. 6 also shows the state that the valve portion 17 of the bushing 13 is contacted strongly to the exterior 3a of the cord 3. In FIG. 6, the valve portion 17 is lightly deformed with an elastication to the guide side 20.

Herebelow, one example of the size of the headphone's parts is shown. The external diameter of the cord 3 shown in FIG. 3 is 1.4 mm. The internal diameter of the inner face 13a of the bushing 13 shown in FIG. 4 is 1.7 mm. The internal diameter that is formed by the cord side 18 of the valve portion 17 is 1.3 mm. Thereof, the width of a gap g shown in FIG. 4 is 0.2 mm ((1.7 mm−1.3 mm)/2=0.2 mm)). The internal diameter of the valve portion 17 is established that it is 0.1 mm (1.4 mm−1.3 mm) smaller than the external diameter of the cord 3.

In the above, the first embodiment has been described. The first embodiment has characteristics explained in below.

The headphone 1 of the first embodiment is consisted of the driver unit 4 (the electro-acoustic tranducer), the cord 3, the housing 5, and the bushing 13. The driver unit 4 generates sound waves based on supplied audio signals. The cord 3 is connected to the driver unit 4 for providing the audio signals to the driver unit 4. The housing 5 stores the driver unit 4 and has the cord inserted hole 10. The bushing 13 is a tube covering the exterior 3a of the cord 3 with a gap g to protect the code 3 from a wire breakage caused by bending. The exterior 3a of the code 3 corresponds to the outer of the cover 9 of the code 3. The bushing 13 is set to the cord inserted hole 10. Moreover, the valve portion 17 that contacts circularized with the exterior of the cord 13 is formed on the inner face 13a of the bushing 13.

According to the structure explained in above, if a foreign matter, for example sweat, drop of water and dust, enters the gap g between the bushing 13 and the code 3, the foreign matter cannot reach to the driver unit 4 and the a cavity 21 because of an existence of the valve portion 17. Thereof, the headphone 1 can have a performance that, if the foreign matter enters the gap g between the bushing 13 and the code 3, it could not been affected for the performance.

The cord 3 of the headphone 1 has an extremely high elastic behavior compared with other field.

The bushing 13 includes the unbended portion 15, limited to bend as set in the housing 5, and the bendable portion 16, allowed to bend as exposed from the housing 5. The valve portion 17 is formed on the unbended portion 15 of the bushing 13.

According to the structure explained in above, even when the bendable portion 16 is bent, a performance of adhesion of the valve portion 17 can not be decreased. Moreover, when the bendable portion 16 is bent, a deformation of the valve portion 17 is suppressed. Thereof, if the foreign matter enters the gap g between the bushing 13 and the code 3, the headphone 1 can keep its performance by a function described above that prevents the foreign matter to enter.

It is preferably that the valve portion 17 is formed at the end 13b (a first end) that works as the end of the bushing 13 on the driver unit 4's side shown in FIGS. 3 and 4.

When the cord 3 is inserted to the bushing 13 from the end 13c (a second end), an opposite side to the end 13b, to the end 13b, there is a case that the cord 3 is not inserted to the bushing 13 as caught in the valve portion 17. According to the structure explained in above, even if the cord 3 is caught in the valve portion 17 as inserted to the bushing 13, the tip of the cord 3 on the inserted side can be picked up from the end 13b's side of the bushing 13 because the valve portion 17 is formed in the end 13b of the bushing 13. Moreover, the guide side 20 of the valve portion 17 is formed gradually getting narrower to the inserted direction's side. Consequently, the structure explained in above makes a working performance of an assembly which the headphone 1 with the valve portion 17 is formed improve.

The cord 3 is connected to the driver unit 4 after passing to the bushing 13 and the cavity 21 that is a space between the driver unit 4 and the housing 5.

According to the structure explained in above, the position where the valve portion 17 is formed is changed, thereby the shape of the cavity 21 is changed. However, the described structure, “the valve portion 17 is formed at the end 13b”, makes an effect described below. Because the valve portion 17 is formed at the end 13b, the cavity 21 is not extended to the inner part of the bushing 13. In other words, the shape of the cavity 21 is a unified figure. There is an effect; an acoustic design is easily planed.

The described first embodiment can be changed below.

For example, the ring 14 of the bushing unit 6 is not an essential part and can be omitted.

The guide side 20 of the valve portion 17 getting more inclined as getting closer to a knot 22 is described. However, the guide side 20 of the valve portion 17 can be set getting more inclined as leaving from the knot 22. It is more preferable that the former is adopted for ease of a working property which the cord 3 is inserted to the bushing 13.

### Embodiment 2

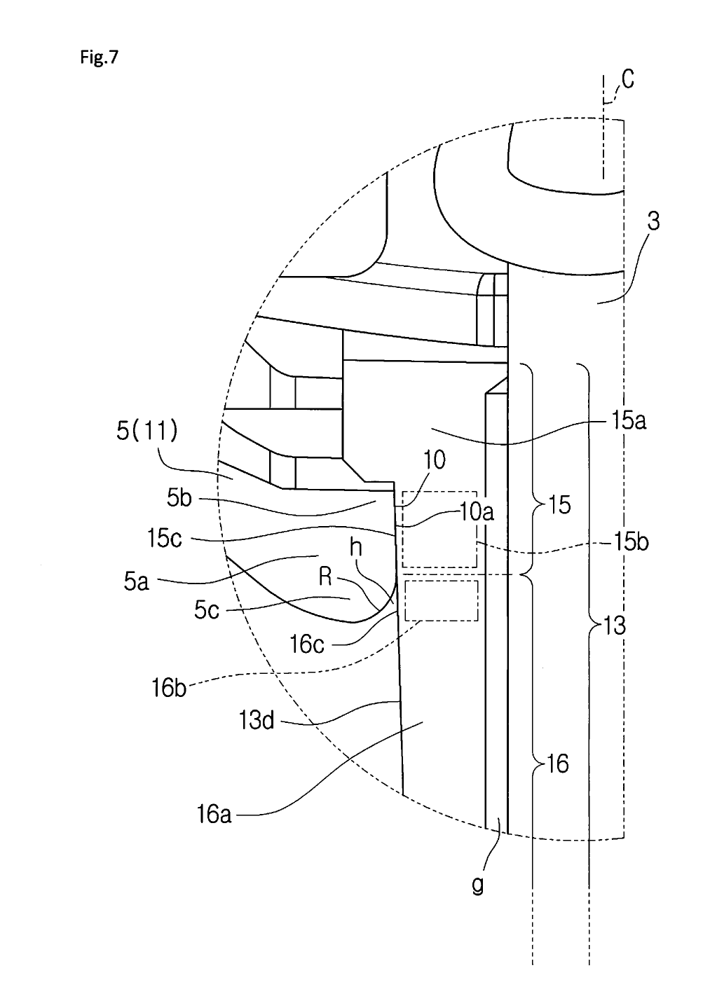

Next, the second embodiment will be described referring FIG. 7. In this section, a point that differs from the first embodiment will be described mainly and the explanation described above will be basically omitted. Elements that correspond to elements in the first embodiment are denoted by same reference numerals. The hatching in FIG. 7 is omitted for an easies of an explanation.

In the second embodiment, a margin 5a surrounds the cord inserted hole 10 of the housing 5 has a curving portion R. In detail, the margin 5a of the housing 5 includes an upper edge 5b and an underside edge 5c. The upper edge 5b is contacted closely to an outer side 13d of the bushing 13. The underside edge 5c is not contacted to the outer side 13d. There is a gap h between the outer side 13d and the underside edge 5c.

In FIG. 7, the unbended portion 15 is a portion that prevents a flexion deformity as set in the housing 5. “The unbended 15” is comprised of the covered portion 15a and the uncovered portion 15b. The covered portion 15a is a portion that is overall housed in the housing 5. The uncovered portion 15b is a portion that is set in the cord inserted hole 10 and is shown with a phantom line in FIG. 7. A gap between the outer face 15c of the uncovered portion 15b and the inner face 10a of the cord inserted hole 10 is not set intentionally. The bendable portion 16 is a portion that allows to bend as not covered by the housing 5. The bendable portion 16 includes an uncovered portion 16a and a covered portion 16b. The uncovered portion 16a is a portion that is fully exposed from the housing 5. The uncovered portion 16a is not covered by the housing 5. On the other hand, the covered portion 16b is a portion in the cord inserted hole 10. The covered portion 16b is shown with a phantom line in FIG. 7. The covered portion 16b and the cord inserted hole 10 are set with a gap h that is between an outer side 16c and the inner face 10a.

In a word, a border between the unbended portion 15 and the bendable portion 16 is determined by an existence of the gap h between the outer side 13d of the bushing 13 and the inner face 10a of the cord inserted hole 10.

What is claimed is:

1. A headphone comprising:
an electro-acoustic tranducer that generates sound waves based on supplied audio signals;
a code connected to the electro-acoustic tranducer for providing the audio signals to the electro-acoustic tranducer;
a housing that has a code-setting hole to be capable to insert the code and storages the electro-acoustic tranducer; and
a bushing that is a cylinder-shaped covering the exterior of the code with a gap for protecting the code from a wire breakage by the code bent and set to the code-setting hole,
wherein the interior of the bushing has a blocking portion for clinging to the exterior of the code.

2. The headphone according to claim 1,
wherein the blocking portion is ring-shaped.

3. The headphone according to claim 1,
wherein the bushing comprise an unbended portion that is not capable to bend as set in the housing and a bendable portion that is capable to bend as not covered with the housing,
wherein the blocking portion is disposed on the unbended portion of the bushing.

4. The headphone according to claim 3,
wherein the blocking portion is disposed at an end that is the electro-acoustic tranducer's side of the bushing.
